(19) United States
(12) Patent Application Publication
(10) Pub. No.: US 2022/0223890 A1
(43) Pub. Date: Jul. 14, 2022

(54) FUEL CELL SYSTEM

(71) Applicants: FUJI ELECTRIC CO., LTD., Kawasaki-shi (JP); MITSUBISHI POWER, LTD., Yokohama-shi (JP)

(72) Inventor: Kuniyuki TAKAHASHI, Kawasaki-shi (JP)

(73) Assignees: FUJI ELECTRIC CO., LTD., Kawasaki-shi (JP); MITSUBISHI POWER, LTD., Yokohama-shi (JP)

(21) Appl. No.: 17/710,993

(22) Filed: Mar. 31, 2022

Related U.S. Application Data
(63) Continuation of application No. PCT/JP2020/044500, filed on Nov. 30, 2020.

(30) Foreign Application Priority Data
Dec. 25, 2019 (JP) 2019-234466

(51) Int. Cl. H01M 8/04664; H01M 8/2425; H01M 8/04746; H01M 8/04089; H01M 8/04007

(52) U.S. Cl. CPC H01M 8/04679; H01M 8/2425; H01M 2008/1293; H01M 8/04089; H01M 8/04067; H01M 8/04753

(57) ABSTRACT

A fuel system includes a fuel cell module including a solid oxide fuel cell stack that generates electricity through an electrochemical reaction between a fuel gas and an oxidant gas, a control unit that controls the fuel cell module, a detection unit for detecting a loss of control by the control unit, and an opening and closing apparatus configured to maintain gases inside the fuel cell module or release the gases in the fuel cell module outside the fuel cell module. The opening and closing apparatus releases the gasses inside the fuel cell module outside the fuel cell module upon detecting a loss of control of the control unit.

### CROSS REFERENCE TO RELATED APPLICATIONS

This is a continuation application of International Application PCT/JP2020/044500 filed on Nov. 30, 2020, which claims priority from a Japanese Patent Application No. 2019-234466 filed on Dec. 25, 2019, the contents of which are incorporated herein by reference.

### BACKGROUND OF THE INVENTION

### Technical Field

The present invention relates to a fuel cell system.

### Background Art

Recently, the development of solid oxide fuel cells (SOFCs) is progressing. An SOFC is a power generation mechanism in which electrical energy is generated by causing oxide ions generated by an air electrode to pass through an electrolyte and move to a fuel electrode, such that the oxide ions react with hydrogen or carbon monoxide at the fuel electrode. SOFCs have the characteristics of having the highest operating temperatures for power generation (for example, from 900° C. to 1000° C.) and also the highest power-generating efficiency among currently known classes of fuel cells.

Patent Literature 1 discloses a solid oxide fuel cell that controls a water supplying apparatus such that water evaporation continues even after fuel supply is stopped, thereby inhibiting a pressure drop on the fuel electrode side of the fuel cell stacks. In this solid oxide fuel cell, the execution of a shutdown stop is attained while also sufficiently inhibiting oxidation of the fuel cells.

### CITATION LIST

### Patent Literature

Patent Literature 1: Japanese Patent Laid-Open No. 2013-225484

### SUMMARY OF INVENTION

However, in the solid oxide fuel cell described in Patent Literature 1, the water supplying apparatus is controlled even after the fuel supply is stopped. Consequently, the technology of Patent Literature 1 is expected to be controllable even after shutdown, and does not anticipate a blackout situation caused by a loss of a control power source or a loss of control by a control device. Moreover, the technology of Patent Literature 1 prevents a loss of pressure at the fuel electrode, but in the case of a high fuel cell temperature, the reaction inside the solid oxide fuel cell will progress and the fuel electrode will be degraded by oxidation, and consequently it is necessary to cool the solid oxide fuel cell.

An object of the present invention, which has been made in the light of such points, is to provide a fuel cell system that can prevent degradation in a solid oxide fuel cell, even in the case where a blackout occurs.

In one aspect, a fuel cell system according to the embodiments comprises a fuel cell module including a solid oxide fuel cell stack that generates electricity through an electrochemical reaction between a fuel gas and an oxidant gas, a control unit that controls the fuel cell module;

a detection unit for detecting a loss of control by the control unit, and an opening and closing apparatus configured to maintain gases inside the fuel cell module, and upon the detection unit detecting a loss of control of the control unit, release the gases from inside to outside the fuel cell module.

According to the present invention, it is possible to provide a fuel cell system that can prevent degradation in a solid oxide fuel cell, even in the case where a blackout occurs.

### BRIEF DESCRIPTION OF DRAWINGS

FIG. 1 is a block diagram illustrating a fuel cell system according to a first embodiment.

FIG. 2 is a block diagram illustrating a fuel cell system according to a second embodiment.

FIG. 3 is a block diagram illustrating a fuel cell system according to a third embodiment.

FIG. 4 is a block diagram illustrating a fuel cell system according to a fourth embodiment.

FIG. 5 is a block diagram illustrating a fuel cell system according to a fifth embodiment.

FIG. 6 is a block diagram illustrating a fuel cell system according to a sixth embodiment.

FIG. 7 is a block diagram illustrating a fuel cell system according to a seventh embodiment.

FIG. 8 is a block diagram illustrating a fuel cell system according to an eighth embodiment.

### DESCRIPTION OF EMBODIMENTS

### First Embodiment

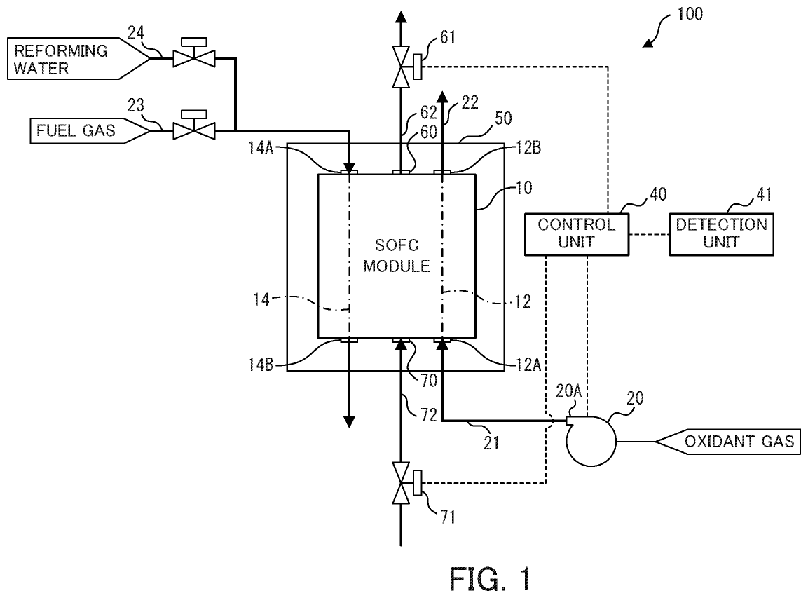

Hereinafter, a fuel cell system 100 according to the present embodiment will be described in detail with reference to the accompanying drawings. FIG. 1 is a block diagram illustrating the fuel cell system 100 according to the first embodiment. For convenience, only the components related to the present invention are illustrated in FIG. 1. In FIG. 1, the flow channels of fluids such as a fuel gas and an oxidant gas are illustrated by solid lines, and signal lines of control signals in the fuel cell system 100 are illustrated by dashed lines. Note that the flow channels of fluids inside an SOFC 10 are illustrated by chain lines for convenience.

As illustrated in FIG. 1, the fuel cell system 100 includes a solid oxide fuel cell module (SOFC module) 10. The SOFC module (hereinafter simply referred to as the “SOFC”) 10 includes a cell stack configured as a layering or a collection of a plurality of cells. Each cell has a basic configuration in which an electrolyte is disposed between an air electrode and a fuel electrode. The cells of the cell stacks are electrically connected in series. The SOFC 10 includes a power generation mechanism in which electrical energy is generated by causing oxide ions generated by an air electrode to pass through an electrolyte and move to a fuel electrode, such that the oxide ions react with hydrogen or carbon monoxide at the fuel electrode.

The SOFC 10 includes an oxidant gas flow channel (cathode gas flow channel) 12 and a fuel gas flow channel (anode gas flow channel) 14. The oxidant gas (air) and other gases brought in by a reaction air blower (oxidant gas supplier) 20 are supplied to an inlet 12A of the oxidant gas flow channel 12, and oxidant off-gas is discharged from an outlet 12B of the oxidant gas flow channel 12. The oxidant gas (air) is supplied to the inlet 12A of the oxidant gas flow channel 12 through an oxidant gas supply line 21 that connects an outlet 20A of the reaction air blower 20 to the inlet 12A of the oxidant gas flow channel 12. Additionally, the oxidant off-gas is discharged from the outlet 12B of the oxidant gas flow channel 12 through an oxidant gas discharge line 22 connected to the outlet 12B of the oxidant gas flow channel 12. Note that the oxidant off-gas may also be referred to as the cathode off-gas. The oxidant gas flow channel 12 is illustrated by a straight line (chain line) inside the SOFC 10, but the flow channel may be set in accordance with the shape of the cell stack.

A fuel gas (fuel) is supplied to an inlet 14A of the fuel gas flow channel 14 from a fuel gas supplier (not illustrated) through a fuel gas supply line 23, and in addition, reforming water and other gases are supplied from a reforming water supplier (not illustrated) through a reforming water supply line 24. Fuel off-gas is discharged from an outlet 14B of the fuel gas flow channel 14. Note that the fuel off-gas may also be referred to as the anode off-gas. A reformed fuel (fuel gas) is generated on the basis of the fuel gas (fuel) supplied from the fuel gas supplier (not illustrated) and the reforming water supplied from the reforming water supplier (not illustrated). Additionally, a direct current (electricity) is generated by inducing an electrochemical reaction between the oxidant gas supplied to the oxidant gas flow channel 12 and the fuel gas supplied to the fuel gas flow channel 14 and generated. Note that a reformer for generating the reformed fuel (fuel gas) based on the fuel gas (fuel) and the reforming water may also be provided outside the SOFC 10.

In the case where a blackout due to a loss of a control power source (hereinafter also simply referred to as a “blackout”) occurs, the supply of the fuel gas (fuel) from the fuel gas supplier (not illustrated) through the fuel gas supply line 23 stops, and in addition, the supply of the reforming water from the reforming water supplier (not illustrated) through the reforming water supply line 24 stops. Similarly, in the case where a blackout occurs, the supply of the air (oxidant gas) from the reaction air blower 20 through the oxidant gas supply line 21 stops. Immediately after a blackout, the SOFC 10 is at a high temperature and highly reactive, and consequently the hydrogen at the fuel electrode and the oxygen at the air electrode inside the SOFC 10 react, and all of the fuel gas (hydrogen) is consumed. However, because the oxidant gas supply line 21 side is not particularly sealed, as the temperature inside the SOFC 10 falls and the volume of gas decreases, outside air flows into the SOFC 10. As a result, the inflowing air reacts with the fuel electrode, causing the fuel electrode to oxidize and become degraded.

The fuel cell system 100 includes a control unit 40 and a detection unit 41. For example, the fuel cell system 100 may include a computing device such as a central processing unit (CPU), and a non-transitory computer-readable storage medium such as a read-only memory (ROM), random-access memory (RAM), magnetic disk storage media, optical storage media, flash-memory devices, and other storage devices and media. The storage medium contains program instructions stored therein, execution of which by the computing device causes the fuel cell system to provide the functions of the control unit 40 and the detection unit 41.

Specifically, the control unit 40 controls the fuel cell system 100 including the SOFC 10. The detection unit 41 detects a loss of control by the control unit 40. The detection unit 41 includes a programmable logic controller (PLC) for example, and can detect whether or not the control by the control unit 40 has been lost by determining whether or not a controller signal transmitted from the control unit 40 on a fixed interval has been received. The detection unit 41 is connected to an uninterruptible power supply (UPS) and can detect a loss of control by the control unit 40 even in the case where a blackout occurs.

For example, the detection unit 41 can detect that the control unit 40 has lost control and a blackout has occurred if the detection unit 41 has not received the controller signal even after a certain time elapses. Additionally, the detection unit 41 may also directly detect the supply of power to the control unit 40. In this case, the detection unit 41 can detect that the control unit 40 has lost control and a blackout has occurred if the supply of power to the control unit 40 has stopped. The control unit 40 as above may constitute means for controlling the fuel cell system 100 including the SOFC 10. Furthermore, the detection unit 41 may constitute means for detecting a loss of control by the control unit 40.

The SOFC 10 is surrounded by a heat-insulating material 50 that keeps the SOFC 10 warm. An opening 60 is provided in the upper vertical end of the SOFC 10. An open line (release line) 62 closed off by a valve 61 is connected to the opening 60. In addition, an opening 70 is provided on the lower vertical end of the SOFC 10. An open line (release line) 72 closed off by a valve 71 is connected to the opening 70. The diameter by which the valve 61 is opened may be approximately the same as the diameter of the oxidant gas discharge line 22. Similarly, the diameter by which the valve 71 is opened may be approximately the same as the diameter of the oxidant gas supply line 21.

The valves 61 and 71 are normally open solenoid valves that maintain a closed state while energized by the control unit 40. Conversely, the valves 61 and 71 open when not energized by the control unit 40, which occurs when the detection unit 41 detects a loss of control by the control unit 40 and a blackout or the like occurs due to a situation such as a loss of power. For this reason, under normal conditions in which a blackout has not occurred, the energized state of the valves 61 and 71 is maintained by the control unit 40, and the closed state of the valves 61 and 71 is also maintained. Consequently, under normal conditions, the hot gas inside the SOFC 10 is not discharged into the atmosphere through the open lines 62 and 72. In contrast, in the case where a blackout occurs due to a loss of power or the like and the control by the control unit 40 is lost, the valves 61 and 71 are no longer energized by the control unit 40, and the valves 61 and 71 open. Consequently, when a blackout occurs, the hot gas inside the SOFC 10 is discharged into the atmosphere through the open lines 62 and 72.

The valve 61, the valve 71, the open line 62, and the open line 72 as above constitute an opening and closing apparatus that opens the SOFC 10. The present embodiment describes a case in which the valves 61 and 71 and the open lines 62 and 72 are included as two valves and corresponding open lines.

In this way, when a blackout occurs in the fuel cell system 100 according to the first embodiment, the valve 61 and the valve 71 are opened. The open line 62 and the open line 72 connected to the valve 61 and the valve 71 are disposed at respectively different heights in the vertical direction of the SOFC 10. Consequently, the hot gas inside the SOFC 10 moves upward and is discharged into the atmosphere through the open line 62 connected to the opening 60 disposed in the top of the SOFC 10. Additionally, atmospheric gas (air) of a volume equal to the gas discharged from inside the SOFC 10 is supplied into the SOFC 10 through the open line 72 connected to the opening 70 disposed in the bottom of the SOFC 10. Immediately after a blackout, the SOFC 10 has an extremely high internal temperature from 700° C. to 900° C., and therefore it is fully possible to cool the SOFC 10 even with room temperature atmospheric gas (air) supplied into the SOFC 10.

Consequently, the fuel cell system 100 according to the first embodiment can discharge the hot gas from inside the SOFC 10, supply atmospheric gas (air), and rapidly lower the temperature of the SOFC 10. As a result, degradation of the SOFC 10 can be prevented, even in the case where a blackout occurs.

Also, in the first embodiment, the open line 62 and the open line 72 penetrate the heat-insulating material 50 surrounding the SOFC 10 to connect to the SOFC 10. For this reason, when a blackout occurs, the hot gas inside the SOFC 10 is discharged into the atmosphere directly through the open line 62, without going through the heat-insulating material 50. Additionally, the SOFC 10 can be cooled by supplying the atmospheric gas (air) directly to the SOFC 10 through the open line 72, without going through the heat-insulating material 50. With this arrangement, even if a blackout occurs, the temperature of the SOFC 10 can be lowered rapidly without having to consider the heat-insulating effect provided by the heat-insulating material 50. As a result, degradation of the SOFC 10 can be prevented.

### Second Embodiment

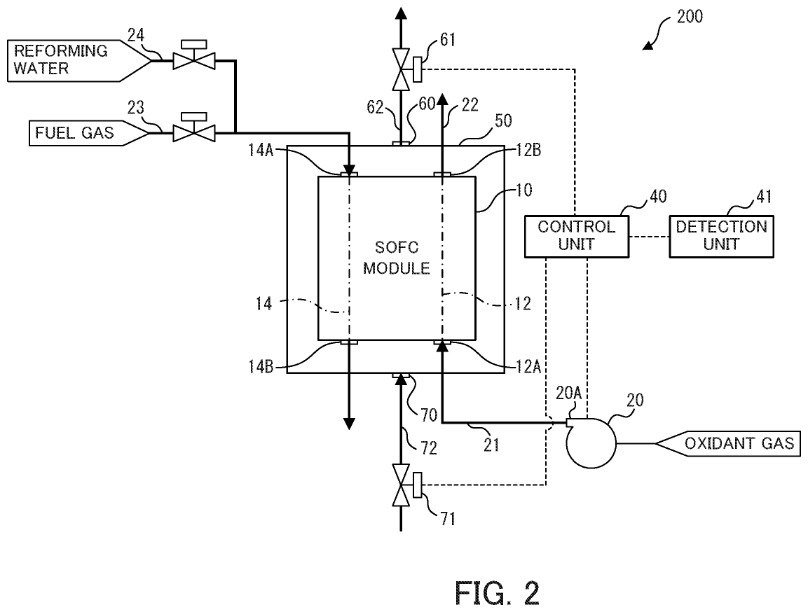

A fuel cell system 200 according to a second embodiment differs from the first embodiment in that the open line 62 and the open line 72 are connected to the SOFC 10 through the heat-insulating material 50 surrounding the SOFC 10. FIG. 2 is a block diagram illustrating the fuel cell system 200 according to the second embodiment. Note that in the embodiment described hereinafter, components that are the same as the first embodiment already described will be denoted with the same reference signs, and duplicate description of such components will be omitted or simplified.

The SOFC 10 is surrounded by a heat-insulating material 50 that keeps the SOFC 10 warm. An opening 60 is provided in the upper end of the heat-insulating material 50 on the top of the SOFC 10. An open line 62 closed off by a valve 61 is connected to the opening 60. In addition, an opening 70 is provided in the lower end of the heat-insulating material 50 on the bottom of the SOFC 10. An open line 72 closed off by a valve 71 is connected to the opening 70. In other words, in the fuel cell system 200 according to the second embodiment, the open line 62 and the open line 72 are connected to the SOFC 10 through the heat-insulating material 50, without penetrating the heat-insulating material 50.

When a blackout occurs in the fuel cell system 200 according to the second embodiment, the valve 61 and the valve 71 are opened. Additionally, the hot gas inside the SOFC 10 moves upward through the SOFC 10 and the heat-insulating material 50 and is discharged into the atmosphere through the open line 62 connected to the opening 60 disposed in the heat-insulating material 50 on the top of the SOFC 10. Additionally, atmospheric gas (air) of a volume equal to the gas discharged from inside the SOFC 10 is supplied into the SOFC 10 through the open line 72 connected to the opening 70 disposed in the heat-insulating material 50 on the bottom of the SOFC 10. Immediately after a blackout, the SOFC 10 has an extremely high internal temperature from 700° C. to 900° C., and therefore it is fully possible to cool the SOFC 10 even with room temperature atmospheric gas (air) supplied to the SOFC 10 through the heat-insulating material 50.

Consequently, the fuel cell system 200 according to the second embodiment can discharge the hot gas from inside the SOFC 10 and supply atmospheric gas (air) through the heat-insulating material 50, and rapidly lower the temperature of the SOFC 10. As a result, degradation of the SOFC 10 can be prevented, even in the case where a blackout occurs.

Also, in the second embodiment, the open line 62 and the open line 72 are connected to the SOFC 10 through the heat-insulating material 50 without penetrating the heat-insulating material 50 surrounding the SOFC 10. For this reason, when a blackout occurs, the hot gas inside the SOFC 10 is discharged into the atmosphere through the open line 62 and the heat-insulating material 50. Additionally, the SOFC 10 can be cooled by supplying the atmospheric gas (air) to the SOFC 10 through the open line 72 and the heat-insulating material 50. With this arrangement, the temperature of the SOFC 10 can be lowered rapidly when a blackout occurs. As a result, degradation of the SOFC 10 can be prevented. Furthermore, it is not necessary to modify existing equipment such as the heat-insulating material 50, thereby conserving the heat-insulating effect provided by the heat-insulating material 50 and suppressing a reduction in the power-generating efficiency of the fuel cell system 200.

### Third Embodiment

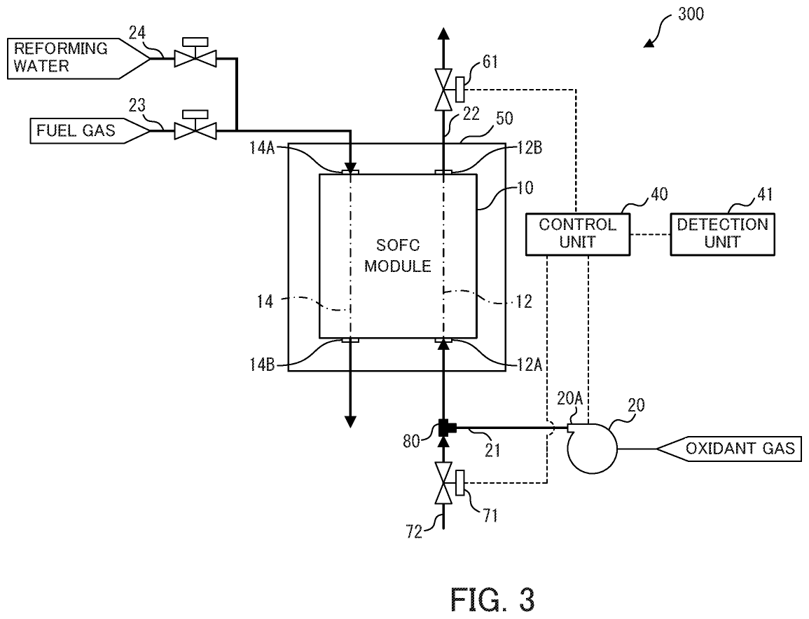

A fuel cell system 300 according to a third embodiment differs from the first embodiment in that the valve 61 and the valve 71 are connected to the oxidant gas supply line 21 and the oxidant gas discharge line 22, respectively. FIG. 3 is a block diagram illustrating the fuel cell system 300 according to the third embodiment. Note that in the embodiment described hereinafter, components that are the same as the first embodiment already described will be denoted with the same reference signs, and duplicate description of such components will be omitted or simplified.

In the fuel cell system 300 according to the third embodiment, the valve 61 is directly connected to the oxidant gas discharge line 22. Also, in the fuel cell system 300 according to the third embodiment, the open line 72 closed off by the valve 71 is connected to the oxidant gas supply line 21. The oxidant gas supply line 21 and the valve 71 are connected via a T-shaped pipe 80, for example.

Consequently, in the third embodiment, during a blackout, the hot gas inside the SOFC 10 can be discharged through the valve 61 connected to the oxidant gas discharge line 22. In addition, atmospheric gas (air) can be supplied through the valve 71 connected to the oxidant gas supply line 21. With this arrangement, the temperature of the SOFC 10 can be lowered rapidly. As a result, degradation of the SOFC 10 can be prevented, even in the case where a blackout occurs. The oxidant gas supply line 21 as above constitutes an oxidant gas supplying unit that supplies the oxidant gas to the SOFC 10. Also, the oxidant gas discharge line 22 constitutes an oxidant gas discharging unit that discharges the oxidant gas from the SOFC 10.

In other words, in the third embodiment, the existing equipment configuration can be utilized without provided a separate configuration such as the opening 60 and the opening 70 like in the first embodiment, and when a blackout occurs, the SOFC 10 can be cooled rapidly to prevent degradation of the SOFC 10. With this arrangement, a reduction in cost can be attained. Furthermore, it is not necessary to modify existing equipment such as the heat-insulating material 50, thereby conserving the heat-insulating effect provided by the heat-insulating material 50 and suppressing a reduction in the power-generating efficiency of the fuel cell system 300.

### Fourth Embodiment

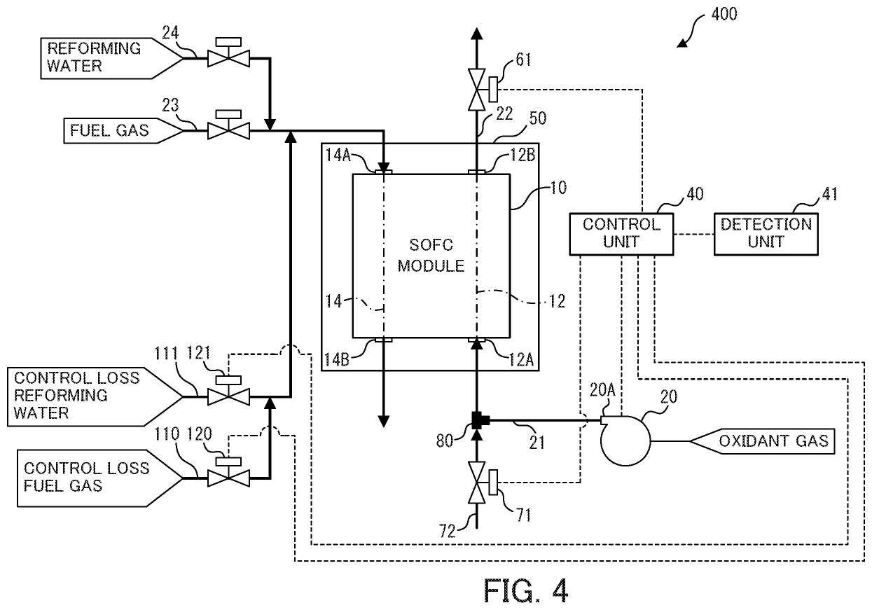

A fuel cell system 400 according to a fourth embodiment differs from the third embodiment in that a control loss fuel supply line 110 and a control loss reforming water supply line 111 are disposed. FIG. 4 is a block diagram illustrating the fuel cell system 400 according to the fourth embodiment. Note that in the embodiment described hereinafter, components that are the same as the third embodiment already described will be denoted with the same reference signs, and duplicate description of such components will be omitted or simplified.

The control loss fuel supply line 110 is closed off by a valve 120, and connects a fuel cylinder (not illustrated) to the inlet 14A of the fuel gas flow channel 14. Also, the control loss reforming water supply line 111 is closed off by a valve 121, and connects a reforming water cylinder (not illustrated) to the inlet 14A of the fuel gas flow channel 14.

The valves 120 and 121 are normally open solenoid valves that maintain a closed state while energized by the control unit 40. Conversely, the valves 120 and 121 open when not energized by the control unit 40, which occurs when the detection unit 41 detects a loss of control by the control unit 40 and a blackout or the like occurs due to a situation such as a loss of power. For this reason, under normal conditions in which a blackout has not occurred, the energized state of the valves 120 and 121 is maintained by the control unit 40, and the closed state of the valves 120 and 121 is also maintained. Consequently, under normal conditions, the fuel gas and the reforming water are not supplied to the SOFC 10 from the fuel cylinder (not illustrated) and the reforming water cylinder (not illustrated) through the control loss fuel supply line 110 and the control loss reforming water supply line 111. In contrast, in the case where a blackout occurs due to a loss of power or the like and the control by the control unit 40 is lost, the valves 120 and 121 are no longer energized by the control unit 40, and the valves 120 and 121 open. For this reason, in the case where a blackout occurs, the fuel gas is supplied from the fuel cylinder (not illustrated) to the SOFC 10 through the control loss fuel supply line 110. Similarly, the reforming water is supplied from the reforming water cylinder (not illustrated) to the SOFC 10 through the control loss reforming water supply line 111.

Note that the flow rate of the fuel gas supplied from the fuel cylinder (not illustrated) through the control loss fuel supply line 110 may be lower than the flow rate of the fuel gas supplied through the fuel gas supply line 23 when a blackout has not occurred, and may be approximately 1/10 if the temperature is lowered sufficiently. Similarly, the flow rate of the reforming water supplied from the reforming water cylinder (not illustrated) through the control loss reforming water supply line 111 may be lower than the flow rate of the reforming water supplied through the reforming water supply line 24 under normal conditions while a blackout has not occurred, and may be approximately 1/10 if the temperature is lowered sufficiently. The control loss fuel supply line 110 as above constitutes a control loss fuel supplying unit that supplies the fuel gas to the SOFC 10 in the case where the detection unit 41 detects a loss of control by the control unit 40. Also, the control loss reforming water supply line 111 constitutes a control loss reforming water supplying unit that supplies the reforming water to the SOFC 10 in the case where the detection unit 41 detects a loss of control by the control unit 40.

In the fourth embodiment, even in the case where a blackout occurs and the supply of the fuel gas (fuel) through the fuel gas supply line 23 is stopped, the fuel gas is supplied from the fuel cylinder (not illustrated) to the SOFC 10 through the control loss fuel supply line 110. Similarly, even in the case where a blackout occurs and the supply of the reforming water through the reforming water supply line 24 is stopped, the reforming water is supplied from the reforming water cylinder (not illustrated) to the SOFC 10 through the control loss reforming water supply line 111. With this arrangement, reduction gas is generated by a reforming reaction, and consequently a reduction state can be achieved inside the SOFC 10 and degradation caused by the oxidation of the fuel electrode of the SOFC 10 can be deterred. Furthermore, since the reforming reaction is an endothermic reaction, the cooling of the SOFC 10 can be promoted by the achievement of the reduction state.

Consequently, when a blackout occurs, the hot gas inside the SOFC 10 can be discharged through the valve 61 connected to the oxidant gas discharge line 22, while in addition, atmospheric gas (air) can be supplied through the valve 71 connected to the oxidant gas supply line 21. With this arrangement, in the fourth embodiment, the temperature of the SOFC 10 can be lowered rapidly. Furthermore, with the reduction state, degradation caused by the oxidation of the fuel electrode can be deterred. Moreover, the cooling of the SOFC 10 can be promoted by the endothermic reforming reaction.

### Fifth Embodiment

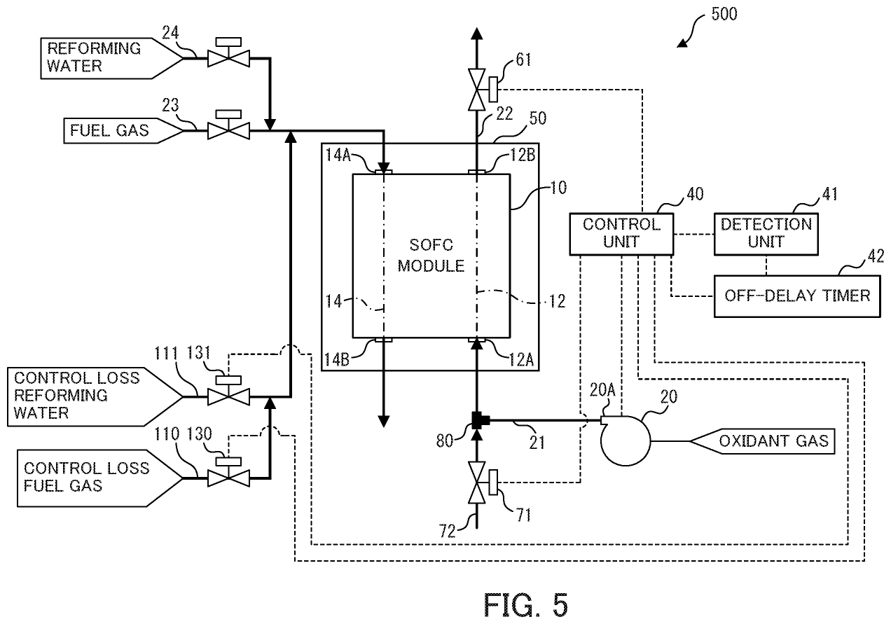

A fuel cell system 500 according to a fifth embodiment differs from the fourth embodiment in that an off-delay timer 42 is provided. FIG. 5 is a block diagram illustrating the fuel cell system 500 according to the fifth embodiment. Note that in the embodiment described hereinafter, components that are the same as the fourth embodiment already described will be denoted with the same reference signs, and duplicate description of such components will be omitted or simplified.

The control loss fuel supply line 110 according to the fifth embodiment is closed off by a valve 130, and connects a fuel cylinder (not illustrated) to the inlet 14A of the fuel gas flow channel 14. Also, the control loss reforming water supply line 111 is closed off by a valve 131, and connects a reforming water cylinder (not illustrated) to the inlet 14A of the fuel gas flow channel 14.

The control unit 40 and the off-delay timer 42 according to the fifth embodiment are connected to an uninterruptible power supply and can count a predetermined time even in the case where a blackout occurs. Also, the valves 130 and 131 are solenoid valves that maintain a closed state under normal conditions while a loss of control by the control unit 40 is not detected by the detection unit 41. In contrast, the valves 130 and 131 open when the detection unit 41 detects a loss of control by the control unit 40 and a blackout or the like occurs due to a situation such as a loss of power. For example, under normal conditions in which a blackout has not occurred, the energized state of the valves 130 and 131 is maintained by the control unit 40, and the closed state of the valves 130 and 131 is also maintained. Consequently, under normal conditions, the fuel gas and the reforming water are not supplied to the SOFC 10 from the fuel cylinder (not illustrated) and the reforming water cylinder (not illustrated) through the control loss fuel supply line 110 and the control loss reforming water supply line 111. In contrast, in the case where a blackout occurs due to a loss of power or the like and the control by the control unit 40 is lost, the valves 130 and 131 are no longer energized by the control unit 40, and the valves 130 and 131 open. For this reason, in the case where a blackout occurs, the fuel gas is supplied from the fuel cylinder (not illustrated) to the SOFC 10 through the control loss fuel supply line 110. Similarly, the reforming water is supplied from the reforming water cylinder (not illustrated) to the SOFC 10 through the control loss reforming water supply line 111.

The off-delay timer 42 starts a count when the detection unit 41 detects a loss of control by the control unit 40. Thereafter, when a predetermined time has elapsed since the start of the count, the off-delay timer 42 cancels the energization of the valve 130 through the control unit 40 and stops the supply of the control loss fuel gas through the control loss fuel supply line 110. Similarly, when a predetermined time has elapsed since the start of the count, the off-delay timer 42 cancels the energization of the valve 131 through the control unit 40 and stops the supply of the control loss reforming water through the control loss reforming water supply line 111. A time long enough for the temperature of the SOFC 10 to drop can be set as the predetermined time, for example. The off-delay timer 42 as above constitutes a supply stopping unit that stops the supply of the fuel gas through the control loss fuel supply line 110 and/or the supply of the reforming water through the control loss reforming water supply line 111 in the case where the predetermined time has elapsed since the detection unit 41 detected a loss of control by the control unit 40.

In the fifth embodiment, at a timing after enough time for the temperature of the SOFC 10 to drop has elapsed, for example, the supply of the control loss fuel gas through the control loss fuel supply line 110 and the supply of the control loss reforming water through the control loss reforming water supply line 111 are stopped. This arrangement makes it possible to conserve the quantity of the fuel supplied through the control loss fuel supply line 110 and the quantity of the reforming water supplied through the control loss reforming water supply line 111. As a result, the number of installed fuel cylinders (not illustrated) and reforming water cylinders (not illustrated) can be decreased, the fuel cell system 500 can be scaled down, and cost savings can be attained.

### Sixth Embodiment

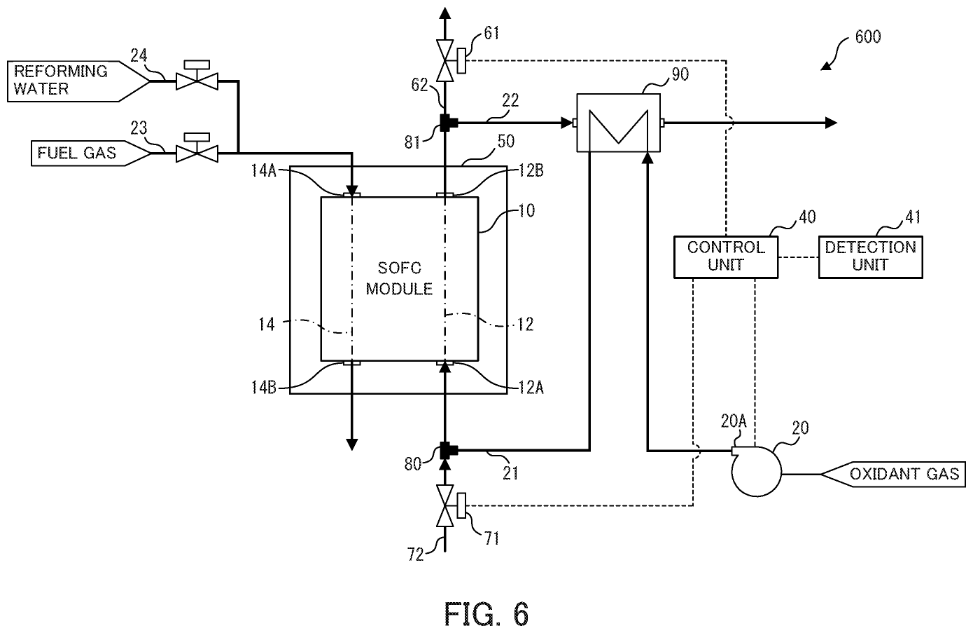

A fuel cell system 600 according to a sixth embodiment differs from the third embodiment in that the valves 61 and 71 are each disposed closer to the SOFC 10 side than a heat exchanger 90. FIG. 6 is a block diagram illustrating the fuel cell system 600 according to the sixth embodiment. Note that in the embodiment described hereinafter, components that are the same as the third embodiment already described will be denoted with the same reference signs, and duplicate description of such components will be omitted or simplified.

In the fuel cell system 600 according to the sixth embodiment, a heat exchanger 90 is connected to the oxidant gas supply line 21 and the oxidant gas discharge line 22. The heat exchanger 90 transfers heat from the oxidant off-gas flowing through the oxidant gas discharge line 22 to the oxidant gas flowing through the oxidant gas supply line 21. In the fuel cell system 600 according to the sixth embodiment, the open line 72 closed off by the valve 71 is disposed with respect to the oxidant gas supply line 21 closer to the SOFC 10 than the heat exchanger 90. For example, the open line 72 closed off by the valve 71 is connected to the oxidant gas supply line 21 through the T-shaped pipe 80 closer to the SOFC 10 side than the heat exchanger 90. Also, in the fuel cell system 600 according to the sixth embodiment, the open line 62 closed off by the valve 61 is disposed with respect to the oxidant gas discharge line 22 closer to the SOFC 10 side than the heat exchanger 90. For example, the open line 62 closed off by the valve 61 is connected to the oxidant gas discharge line 22 through a T-shaped pipe 81 closer to the SOFC 10 side than the heat exchanger 90.

Consequently, in the fuel cell system 600 according to the sixth embodiment, during a blackout, the hot gas inside the SOFC 10 can be discharged through the valve 61 disposed with respect to the oxidant gas discharge line 22 closer to the SOFC 10 side than the heat exchanger 90. The open line 62 provided with the valve 61 is disposed with respect to the oxidant gas discharge line 22 closer to the SOFC 10 side than the heat exchanger 90. With this arrangement, the discharge of the hot gas inside the SOFC 10 toward the heat exchanger 90 side can be deterred. Consequently, even if the oxidant gas (air) leaks in from the gaps or the like in the reaction air blower 20, a rise in the temperature of the oxidant gas supplied from the oxidant gas supply line 21 through heat exchanger 90 due to the heat of the oxidant off-gas can be suppressed, and a rise in the temperature of the SOFC 10 can be suppressed.

Additionally, in the fuel cell system 600 according to the sixth embodiment, during a blackout, atmospheric gas (air) can be supplied into the SOFC 10 through the valve 71 disposed with respect to the oxidant gas supply line 21 closer to the SOFC 10 side than the heat exchanger 90. The open line 72 provided with the valve 71 is disposed with respect to the oxidant gas supply line 21 closer to the SOFC 10 side than the heat exchanger 90. Consequently, when a blackout occurs, atmospheric gas (air) at a normal temperature can be supplied directly into the SOFC 10 rather than the hot air (oxidant gas) that has absorbed heat in the heat exchanger 90. Consequently, when a blackout occurs, the temperature of the SOFC 10 can be lowered rapidly and degradation of the SOFC 10 can be prevented.

### Seventh Embodiment

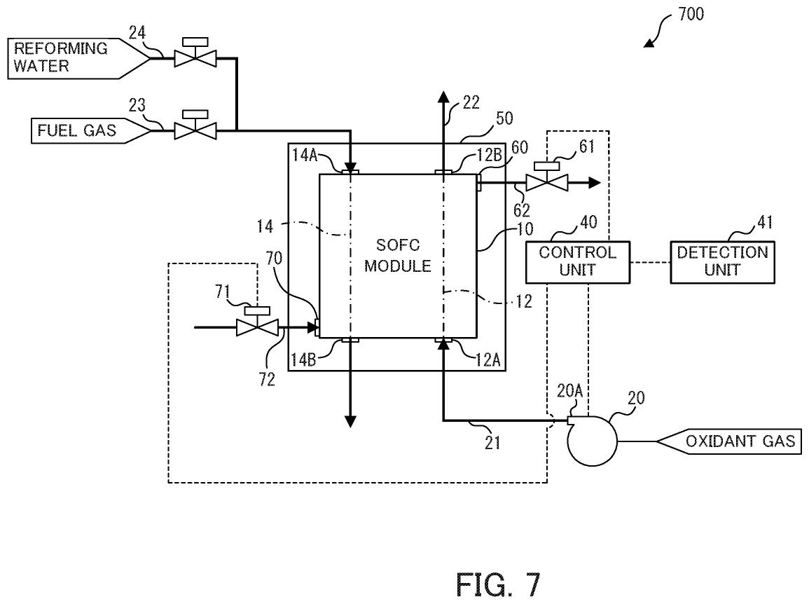

A fuel cell system 700 according to a seventh embodiment differs from the first embodiment in that the valves 61 and 71 are disposed on the vertical sides of the SOFC 10. FIG. 7 is a block diagram illustrating the fuel cell system 700 according to the seventh embodiment. Note that in the embodiment described hereinafter, components that are the same as the first embodiment already described will be denoted with the same reference signs, and duplicate description of such components will be omitted or simplified.

In the fuel cell system 700 according to the seventh embodiment, the opening 60 is provided on an upper vertical side of the SOFC 10. The open line 62 closed off by the valve 61 is connected to the opening 60 in the direction orthogonal to the vertical direction of the SOFC 10, or in other words the horizontal direction. In addition, the opening 70 is provided on a lower vertical side of the SOFC 10. The open line 72 closed off by the valve 71 is connected to the opening 70 in the direction orthogonal to the vertical direction of the SOFC 10, or in other words the horizontal direction.

Consequently, the open lines 62 and 72 of the fuel cell system 700 according to the seventh embodiment do not project out in the vertical direction of the SOFC 10. For this reason, the vertical dimension (height dimension) of the fuel cell system 700 can be reduced. As a result, even in the case of loading the fuel cell system 700 onto a truck or the like for transport along a route with a height limit, for example, it is easy to keep the height dimension of the fuel cell system 700 within the limit. Moreover, even in the case of installing the fuel cell system 700 in an installation location with a height limit, the open line 62 closed off by the valve 61 and the open line 72 closed off by the valve 71 can be connected without worrying about the dimensions in the vertical direction. In addition, since there are no vertical projections underneath, the ground contact surface can be made flat and a stable installation environment can be provided.

### Eighth Embodiment

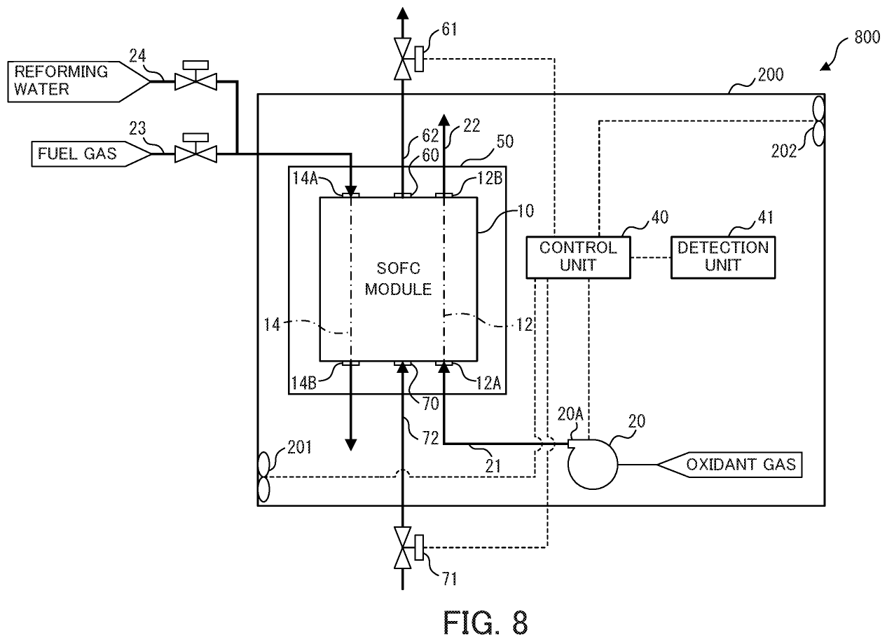

A fuel cell system 800 according to an eighth embodiment differs from the first embodiment in that the SOFC 10 is disposed inside a housing 200 and the open lines 62 and 72 are connected to the SOFC 10 through the housing 200. FIG. 8 is a block diagram illustrating the fuel cell system 800 according to the eighth embodiment. Note that in the embodiment described hereinafter, components that are the same as the first embodiment already described will be denoted with the same reference signs, and duplicate description of such components will be omitted or simplified.

In the fuel cell system 800 according to the eighth embodiment, the SOFC 10 is surrounded by the housing 200. The housing 200 protects the SOFC 10 from wind and rain, and also from the viewpoint of crime prevention. An inlet 201 and an outlet 202 are disposed in the housing 200. The inlet 201 and the outlet 202 include a fan, for example. The inlet 201 introduces an outside gas (air) into the housing 200 under control by the control unit 40. The outlet 202 discharges the gas (air) inside the housing 200 to the outside under control by the control unit 40. However, in the case where there is a loss of power and a blackout occurs, the control by the control unit 40 is lost, the inlet 201 and the outlet 202 stop, and as a result, the temperature inside the housing 200 rises.

In contrast, in the eighth embodiment, the open line 62 and the open line 72 penetrate the housing 200 surrounding the SOFC 10 to connect to the SOFC 10. Consequently, even in the case where a blackout occurs and the inlet 201 and the outlet 202 stop, the hot gas inside the SOFC 10 can be discharged through the open line 62 to the atmosphere outside of the housing 200. Furthermore, atmospheric gas (air) on the outside of the housing 200 can be supplied directly through the open line 72 to cool the SOFC 10 directly. With this arrangement, even if a blackout occurs, the temperature of the SOFC 10 can be lowered rapidly without having to consider the heat-insulating effect provided by the housing 200. As a result, degradation of the SOFC 10 can be prevented.

Note that the present invention is not limited to the embodiments described above, and various modifications are possible. In the embodiments described above, properties such as the sizes, shapes, and functions of the components illustrated in the accompanying drawings are not limited to what is illustrated, and such properties may be modified appropriately insofar as the effects of the present invention are still achieved. Otherwise, other appropriate modifications are possible without departing from the scope of the present invention.

The fuel cell system 100 according to the above embodiments describes a case where the control unit 40 losing control when a controller signal is no longer received after a certain time elapses is used as a detection unit configured to detect a loss of control by the control unit 40. However, the configuration of the detection unit configured to detect a loss of control by the control unit 40 is not limited to the above and may be changed appropriately.

Also, in the fuel cell system 100 according to the above embodiments, two valves (the valve 61 and the valve 71) and two corresponding open lines (the open line 62 and the open line 72) are disposed as an opening and closing apparatus that opens the SOFC 10. However, it is sufficient if there is at least one opening and closing apparatus that opens the SOFC 10, and three or more opening and closing apparatuses may also be disposed. In this case, at least two or more opening and closing apparatuses are preferably disposed at different heights in the vertical direction of the SOFC 10.

Also, in the fuel cell system 300 according to the above embodiments, the open line 62 and the open line 72 are connected to the oxidant gas supply line 21 and the oxidant gas discharge line 22, respectively, but are not limited thereto. For example, at least one of the open line 62 or the open line 72 may be connected to the oxidant gas supply line 21 or the oxidant gas discharge line 22.

### INDUSTRIAL APPLICABILITY

The fuel cell system according to the present invention can prevent degradation in a solid oxide fuel cell even in the case where a blackout occurs for the solid oxide fuel cell, and is suitable for application to fuel cell systems for domestic use, commercial use, and all other industrial fields.

This application is based on Japanese Patent Application No. 2019-234466 filed on Dec. 25, 2019, the content of which is hereby incorporated in entirety.

What is claimed is:

1. A fuel cell system, comprising:
a fuel cell module including a solid oxide fuel cell stack that generates electricity through an electrochemical reaction between a fuel gas and an oxidant gas;
a control unit that controls the fuel cell module;
a detection unit for detecting a loss of control by the control unit; and
an opening and closing apparatus configured to maintain gases inside the fuel cell module, and upon the detection unit detecting a loss of control of the control unit, release the gases from inside to outside the fuel cell module.

2. The fuel cell system according to claim 1, wherein the opening and closing apparatus is disposed at an upper side in the fuel cell system in a vertical direction with respect to a position of the fuel cell module.

3. The fuel cell system according to claim 1, wherein the opening and closing apparatus is provided in plurality, and the plurality of opening and closing apparatuses are each disposed at different heights in the fuel cell system in a vertical direction with respect to a position of the fuel cell module.

4. The fuel cell system according to claim 1, further comprising a heat-insulating material that surrounds the fuel cell module, wherein
the opening and closing apparatus includes a release line that penetrate through the heat-insulating material to release the gases from inside to outside the fuel cell module.

5. The fuel cell system according to claim 1, further comprising:
an oxidant gas supplier that supplies the oxidant gas to the fuel cell module, or an oxidant gas discharger that discharges the oxidant gas from the fuel cell module, wherein
the opening and closing apparatus is connected to at least one of the oxidant gas supplier or the oxidant gas discharger.

6. The fuel cell system according to claim 1, further comprising:
a control loss fuel supplier that supplies the fuel gas to the fuel cell module upon the detection unit detecting the loss of control of the control unit; and
a control loss reforming water supplier that supplies reforming water to the fuel cell module upon the detecting unit detecting the loss of control of the control unit.

7. The fuel cell system according to claim 6, further comprising:
a supply stopper that stops supply of the fuel gas by the control loss fuel supplier and/or supply of the reforming water by the control loss reforming water supplier after a predetermined time has passed since the detection unit detects the loss of control of the control unit.

8. The fuel cell system according to claim 5, further comprising:
a heat exchanger that transfers heat from the oxidant gas from the oxidant gas discharger to the oxidant gas flowing through the oxidant gas supplier, wherein
the opening and closing apparatus is disposed closer to the fuel cell module than is the heat exchanger.

9. The fuel cell system according to claim 1, wherein
the fuel cell module includes a housing, and the solid oxide fuel cell stack is disposed inside the housing, and
the opening and closing apparatus includes a release line that penetrate through the housing to release the gases from inside to outside the fuel cell module.

10. A fuel cell system, comprising:
a fuel cell module including a solid oxide fuel cell stack that generates electricity through an electrochemical reaction between a fuel gas and an oxidant gas;
an opening and closing apparatus configured to maintain gases inside the fuel cell module;
a computing device; and
a storage medium containing program instructions stored therein, execution of which by the computing device causes the fuel cell system to provide the functions of:
a control unit that controls the fuel cell module,
a detection unit for detecting a loss of control by the control unit, wherein
upon the detection unit detecting a loss of control of the control unit, the opening and closing apparatus is configured to release the gases from inside to outside the fuel cell module.
